(19) United States
(12) Patent Application Publication
(10) Pub. No.: US 2026/0361521 A1
(43) Pub. Date: Nov. 12, 2026

(54) IMPROVEMENTS TO QKD SYSTEMS

(71) Applicant: British Telecommunications Public Limited Company, London (GB)

(72) Inventor: Andrew LORD, London (GB)

(21) Appl. No.: 19/488,744

(22) PCT Filed: May 7, 2024
(86) PCT No.: PCT/EP2024/062641

§ 371 Date: Nov. 28, 2025

(30) Foreign Application Priority Data
Jun. 2, 2023 (EP) 23177099.1

(51) Int. Cl. H04L 9/08

(52) U.S. Cl. CPC H04L 9/0852

(57) ABSTRACT

There is herein disclosed a quantum transmission apparatus for Quantum Key Distribution (QKD), comprising: a first quantum transmitter and a second quantum transmitter, wherein, in use, the first quantum transmitter prepares a first photon for QKD transmission and the second quantum transmitter prepares a second photon for QKD transmission; a multiplexer for multiplexing the first photon and the second photon onto a quantum output channel using wavelength-division multiplexing; and a transmission processing apparatus, wherein, in use, the transmission processing apparatus: performs processing in relation to generating a quantum key associated with the first photon; and performs processing in relation to generating a quantum key associated with the second photon.

QKD is of growing popularity as an encryption method due to its high level of security. However key generation rates in QKD are low. It therefore takes time to store up enough key material to enable 1:1 encryption of content (i.e. one-time pad encryption). 1:1 encryption is the most secure.

In order to address this, alternative ways of encrypting content using the quantum key material are presently used, including the AES algorithm.

When building QKD networks this problem is exacerbated. The quantum link becomes a bottleneck for the network traffic. One solution to this is to add further QKD links in parallel. However this is expensive, with costs rising linearly with the addition of parallel channels.

It would be desirable to overcome and/or mitigate the above-mentioned and/or other disadvantages of the prior art.

According to a first aspect of the invention there is provided a quantum transmission apparatus for Quantum Key Distribution (QKD), comprising:
A first quantum transmitter and a second quantum transmitter, wherein, in use, the first quantum transmitter prepares a first photon for QKD transmission and the second quantum transmitter prepares a second photon for QKD transmission;
A multiplexer for multiplexing the first photon and the second photon onto a quantum output channel,
And a transmission processing apparatus,
wherein, in use, the transmission processing apparatus:
   (i) performs processing in relation to generating a quantum key associated with the first photon; and
   (ii) performs processing in relation to generating a quantum key associated with the second photon.

According to a second aspect of the invention there is provided a method of Quantum Key Distribution (QKD), the method comprising:
at a first quantum transmitter, preparing a first photon for QKD transmission,
at a second quantum transmitter, preparing a second photon for QKD transmission, multiplexing the first photon and the second photon onto a quantum output channel;
At a transmission processing apparatus:
   (i) performing processing in relation to generating a quantum key associated with the first photon; and
   (ii) performing processing in relation to generating a quantum key associated with the second photon.

Embodiments of the invention enable a QKD method to be performed in which processing apparatus is shared between multiple transmitters and/or multiple receivers. This reduces the total number of components required by the transmitter apparatus/receiver apparatus and hence reduces the cost of the overall system. The use of WDM enables multiple quantum channels to be carried on the same fibre, further reducing cost. Embodiments of the invention therefore enable large-scale quantum key generation at low cost.

The invention is suitable for use with quantum-entanglement protocols, prepare-and-measure protocols, or any other QKD protocol. The multiplexer may use wavelength-division multiplexing. The step of multiplexing the first photon and the second photon onto a quantum output channel may comprise wavelength-division multiplexing.

The transmission processing apparatus may comprise at least one of: a random number generator, a controller, a key agreement processor for performing a key agreement step of QKD with a quantum receiver apparatus, and a quantum key store for storing the resulting quantum keys. The random number generator may be a quasi-random number generator and may provide an input to the first and/or second quantum transmitters for the purpose of preparing the first and/or second photon in a particular basis state. The random number generator may provide an input to the first and/or second quantum transmitters for the purpose of encoding the first and/or second photon with a bit value of 1 or 0.

The first quantum transmitter may comprise a first modulator and the second quantum transmitter may comprise a second modulator. The first modulator may be for preparing a photon in a basis state and the second modulator may be for quantum encoding a bit value onto a photon. The first quantum transmitter may comprise a first attenuator. The second quantum transmitter may comprise a second attenuator.

In some embodiments the processing apparatus comprises a photon source. The photon source may be adapted to output more than one photon at a time and may be adapted to output two or more photons at a time. This may compensate for attenuation in the multiplexer. The photon source may be a frequency comb. In alternative embodiments the first transmitter may comprise a first photon source and the second transmitter may comprise a second photon source. The first photon source and the second photon source may be lasers.

The quantum key associated with the first photon may be generated with a first quantum receiver and the quantum key associated with the second photon may be generated with a second quantum receiver.

The first and second transmitters may be integrated onto a single opto-electronic array. The quantum transmission apparatus may comprise more than 100 transmitters.

One or more of the following transmission components may be functionally disconnectable from, and functionally re-connectable to, a remainder of the plurality of transmission components, for performing QKD: the first quantum transmitter, the second quantum transmitter, the multiplexer, the random number generator, the controller, the key agreement processor for performing a key agreement step of QKD with a quantum receiver apparatus, and the quantum key store.

According to a third aspect of the invention there is provided a quantum receiver apparatus for Quantum Key Distribution (QKD), comprising:
A demultiplexer for demultiplexing a multiplexed quantum signal received from a quantum transmitter to produce a first photon and a second photon;
A first detector for detecting the first photon;
A second detector for detecting the second photon;
At a receiver processing apparatus:
   (i) performing processing in relation to generating a quantum key associated with the first photon; and
   (ii) performing processing in relation to generating a quantum key associated with the second photon.

According to a fourth aspect of the invention there is provided a method of Quantum Key Distribution (QKD), the method comprising:
Demultiplexing a multiplexed quantum signal received from a quantum transmitter to produce a first photon and a second photon;
Detecting the first photon at a first detector;
Detecting the second photon at a second detector;
At a receiver processing apparatus:
   (iii) performing processing in relation to generating a quantum key associated with the first photon; and
   (iv) performing processing in relation to generating a quantum key associated with the second photon.

The receiver processing apparatus may comprise at least one of: a random number generator, a controller, a key agreement processor for performing the key agreement step of QKD with a quantum transmitter apparatus, and a quantum key store for storing the resulting quantum keys. The random number generator may be a quasi-random number generator and may provide an input to a first demodulator for measuring the first photon in a randomly-selected basis state. The random number generator may further provide an input to a second demodulator for measuring the second photon in a randomly-selected basis state. The multiplexed quantum signal may be a wavelength-division-multiplexed quantum signal. The demultiplexer may be for demultiplexing wavelength-division multiplexed signals.

In some embodiments, the quantum key associated with the first photon may be generated by a first quantum transmitter in conjunction with the quantum receiver apparatus and the quantum key associated with the second photon may be generated by a second quantum transmitter in conjunction with the quantum receiver apparatus. These embodiments may use a prepare-and measure QKD protocol.

The quantum key associated with the first photon may be generated by an external quantum receiver in conjunction with the quantum receiver apparatus and the quantum key associated with the second photon may be generated with an external quantum receiver in conjunction with the quantum receiver apparatus. These embodiments may use a quantum-entanglement QKD protocol.

The first detector and/or the second detector may be photodetectors and may be single-photon detectors.

The first quantum receiver and the second receiver transmitter may be integrated onto an opt-electronic array which may be a line card. The line card may be connectable to the QKD receiver apparatus by a clip. Preferably, the one or more of the plurality of receiver components comprises at least 100 further quantum receivers.

One or more of the following receiving components may be functionally disconnectable from, and functionally re-connectable to, a remainder of the plurality of the receiving components, for performing QKD: the first detector, the second detector, the demultiplexer, the random number generator, the controller, the key agreement processor for performing a key agreement step of QKD with a quantum transmitter apparatus, and the quantum key store.

According to a further aspect of the invention there is provided a Quantum Key Distribution (QKD) system comprising:
A quantum transmission apparatus for Quantum Key Distribution (QKD), comprising:
A first quantum transmitter and a second quantum transmitter, wherein, in use, the first quantum transmitter prepares a first photon for QKD transmission and the second quantum transmitter prepares a second photon for QKD transmission;
A multiplexer for multiplexing the first photon and the second photon onto a quantum output channel,
And a transmission processing apparatus,
wherein, in use, the transmission processing apparatus:
   (i) performs processing in relation to generating a quantum key associated with the first photon; and
   (ii) performs processing in relation to generating a quantum key associated with the second photon
      and
a quantum receiver apparatus for Quantum Key Distribution (QKD), comprising:
A demultiplexer for demultiplexing a multiplexed quantum signal received from a quantum transmitter to produce a first photon and a second photon;
A first detector for detecting the first photon;
A second detector for detecting the second photon;
At a receiver processing apparatus:
   (i) performing processing in relation to generating a quantum key associated with the first photon; and
   (ii) performing processing in relation to generating a quantum key associated with the second photon.

A specific embodiment of the invention will now be described in detail, for illustration only, and with reference to the accompanying drawings, in which:

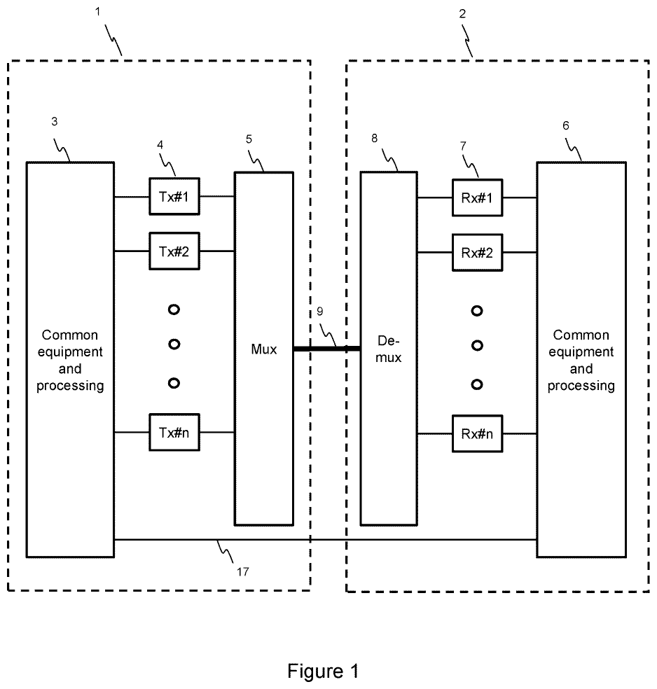

FIG. 1 is a schematic drawing of a QKD system in accordance with the invention;

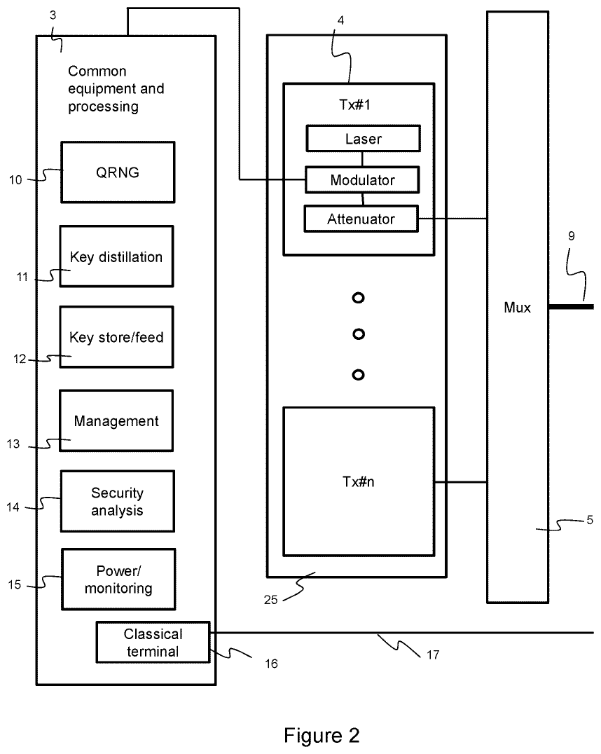

FIG. 2 is a schematic drawing of a transmission node for QKD in accordance with the invention;

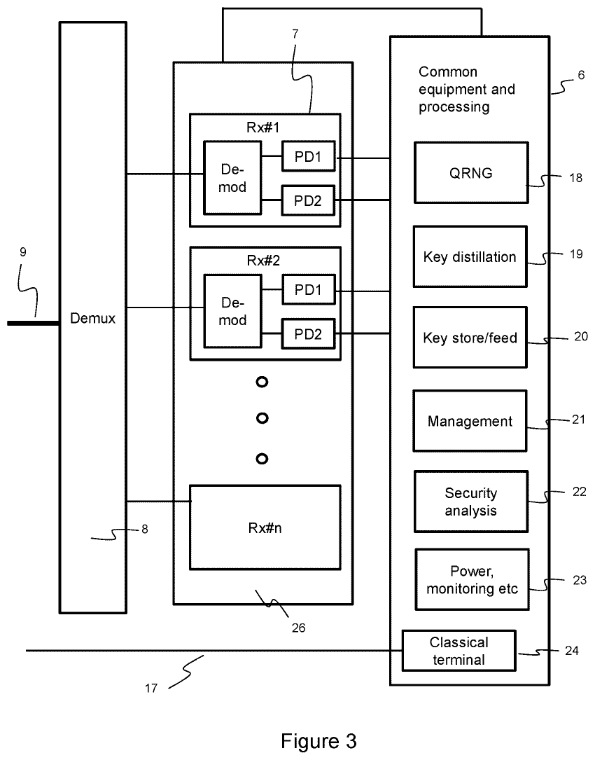

FIG. 3 is a schematic drawing of a receiving node for QKD in accordance with the invention.

A QKD arrangement in accordance with the invention is shown in FIG. 1. In particular, Alice is shown in dotted box 1 and Bob in dotted box 2. Alice contains common equipment and processing unit 3. Common equipment and processing unit 3 provides input signals over optical fibres to n transmitters 4. The n transmitters 4 provide input signals over optical fibres to a multiplexer 5. The multiplexer 5 provides an output signal to optical fibre 9. Optical fibre 9 connects to Bob, and in particular, to a demultiplexer 8. Demultiplexer 8 provides inputs to n receivers 7. Each of the n receivers 7 of Bob is one of a transmitter-receiver pair with one of the n transmitters 4 of Alice. The n receivers 7 provide an input to common equipment and processing unit 6. The common equipment and processing unit 3 of Alice connects to the common equipment and processing unit 6 of Bob by optical fibre 17.

Alice is shown in more detail in FIG. 2. In particular, the common equipment and processing unit 3 contains a quasi-random number generator 10, key distillation module 11, key store/feed 11, management module 12, security analysis module 13, a power/monitoring module 15 and classical terminal 16. As the skilled person would understand, these functions are required for the process of quantum key distribution.

Each of the n transmitters 4 of Alice contains a laser, a modulator and an attenuator. The common equipment and processing unit 3 provides an input to the modulator of each of the n transmitters 4. Each of the attenuators in the n transmitters 4 provides an output to multiplexer 5. The n transmitters 4 are integrated onto an opto-electronic array 25. Opto-electronic array 25 is a single optical chip.

Classical terminal 16 provides an output to optical fibre 17. The laser of each of the n transmitters 4 operates at a different wavelength within the C-band.

Bob is shown in more detail in FIG. 3. In particular, the common equipment and processing unit 6 contains a quasi-random number generator 18, key distillation module 19, key store/feed 20, management module 21, security analysis module 22, a power/monitoring module 23 and classical terminal 24. Classical terminal 24 is connected to optical fibre 17 from classical terminal 16 of Alice.

Demultiplexer 8 of Bob provides inputs to each of the n receivers 7, and in particular to a demodulator in each of the receivers 7. The demodulators each provide an input to two photo detectors. The two photodetectors provide inputs to the common equipment and processing unit 6 of Bob. The n receivers 7 are integrated onto an opto-electronic array 26. Opto-electronic array 26 is a single optical chip.

The method of the invention will now be described. The quasi-random number generator 10 of Alice provides a random number to the modulators of each transmitter 4 of Alice. The laser of each transmitter 4 emits a stream of photons to the modulator of that transmitter. The modulator uses the random number to encode a bit value onto the photon and prepare it in a particular basis state, in a manner that would be familiar to the skilled person. The prepared photon then passes through an attenuator to ensure that only one qubit is transmitted at a time. The photon is then transmitted to the multiplexer 5. Multiplexer 5 modulated the photons output by the n transmitters 4 onto an output signal using wavelength division multiplexing (WDM). The multiplexed signal passes over optical fibre 9 to demultiplexer 8 of Bob.

The quasi-random number generator 18 of Bob generates random numbers and transmits them to the demodulators within each of the n receivers 7 of Bob. The demultiplexer 8 of Bob demultiplexes the signal it received from Alice and provides photons transmitted by each of the n transmitters 4 of Alice to its corresponding receiver 7 of Bob. In particular, the demultiplexer 8 provides the photons to the demodulator of each receiver. The demodulator uses the quasi-random number it has received from the quasi-random number generator 18 of Bob to measure the photon in a randomly-chosen basis state. This will result in one of the two photodetectors in that receiver 7 firing. The outputs of the two photodetectors pass to the key distillation module 19 of Bob.

The key distillation module 19 of Bob uses the inputs from the photodetectors to produce key information which is transmitted to Alice over classical channel 17. Similarly, key distillation module 11 of Alice uses inputs it receives from transmitters 7 to produce key information which is transmitted to Bob over classical channel 17. In this way a quantum key is agreed between Alice and Bob. The thus-produced quantum keys are stored in the key store/feed modules 12 of Alice and 20 of Bob. These can then be used to quantum-encrypt content for secure transmission.

1. A quantum transmission apparatus for Quantum Key Distribution (QKD), comprising:
A first quantum transmitter and a second quantum transmitter, wherein, in use, the first quantum transmitter prepares a first photon for QKD transmission and the second quantum transmitter prepares a second photon for QKD transmission;
A multiplexer for multiplexing the first photon and the second photon onto a quantum output channel using wavelength-division multiplexing;
And a transmission processing apparatus,
wherein, in use, the transmission processing apparatus:
(iii) performs processing in relation to generating a quantum key associated with the first photon; and
(iv) performs processing in relation to generating a quantum key associated with the second photon.

2. A quantum transmission apparatus according to claim 1, further comprising at least one of: a random number generator, a controller, a key agreement processor for performing a key agreement step of QKD with a quantum receiver apparatus, and a quantum key store for storing the resulting quantum keys.

3. A quantum processing apparatus according to claim 2, in which the random number generator provides an input to the first quantum transmitter for the purpose of preparing the first photon in a particular basis state.

4. A quantum processing apparatus according to claim 1, wherein the first quantum transmitter comprises a modulator for preparing the first photon in a basis state and for quantum encoding a bit value onto a photon.

5. A quantum processing apparatus according to claim 1, the first transmitter further comprising a first photon source and the second transmitter further comprising a second photon source.

6. A method of Quantum Key Distribution (QKD), the method comprising:
at a first quantum transmitter, preparing a first photon for QKD transmission,
at a second quantum transmitter, preparing a second photon for QKD transmission,
multiplexing the first photon and the second photon onto a quantum output channel using wavelength-division multiplexing;
At a transmission processing apparatus:
(i) performing processing in relation to generating a quantum key associated with the first photon; and
(ii) performing processing in relation to generating a quantum key associated with the second photon.

7. A quantum receiver apparatus for Quantum Key Distribution (QKD), comprising:
A demultiplexer for demultiplexing a wavelength-division-multiplexed quantum signal received from a quantum transmitter to produce a first photon and a second photon;
A first detector for detecting the first photon;
A second detector for detecting the second photon;
At a receiver processing apparatus:
(iii) performing processing in relation to generating a quantum key associated with the first photon; and
(iv) performing processing in relation to generating a quantum key associated with the second photon.

8. A quantum receiver apparatus according to claim 7, wherein the receiver processing apparatus further comprises at least one of: a random number generator, a controller, a key agreement processor for performing the key agreement step of QKD with a quantum transmitter apparatus, and a quantum key store for storing the resulting quantum keys.

9. A quantum receiver apparatus according to claim 8, wherein the random number generator provides an input to a first demodulator for measuring the first photon in a randomly-selected basis state and further provides an input to a second demodulator for measuring the second photon in a randomly-selected basis state.

10. A method of Quantum Key Distribution (QKD), the method comprising:
Demultiplexing a wavelength-division-multiplexed quantum signal received from a quantum transmitter to produce a first photon and a second photon;
Detecting the first photon at a first detector;
Detecting the second photon at a second detector;
At a receiver processing apparatus:
(v) performing processing in relation to generating a quantum key associated with the first photon; and
(vi) performing processing in relation to generating a quantum key associated with the second photon.
